(19) United States
(12) Patent Application Publication
(10) Pub. No.: US 2002/0062781 A1
(43) Pub. Date: May 30, 2002

(54) Bookmark

(76) Inventors: Judy Glenna Shannon, Rolling Hills, CA (US); Patrick Wayne Klasno, Morongo Valley, CA (US)

Correspondence Address: GARY M. ANDERSON, FULWIDER, PATTON, LEE & UTECHT LLP, 200 OCEANGATE, SUITE 1550, LONG BEACH, CA, 90802, US

(21) Appl. No.: 09/595,515

(22) Filed: Jun. 15, 2000

Related U.S. Application Data
(63) Continuation of application No. 09/136,348, filed on Aug. 19, 1998, now abandoned.

(51) Int. Cl. B42D 9/00

(52) U.S. Cl. 116/234; 281/42

(57) ABSTRACT

A plush toy having an upper torso and head portion of an animal character firmly attached to one end of a ribbon, a lower torso and leg portion of the animal character attached at the ribbon's other end to provide, with the ribbon in the uncoiled position, a bookmark with the ribbon stretching along the spine of the book with the torso portions functioning as anchors, and, in the rolled, or coiled position, to provide a small, plush toy animal in a sitting position.

### BACKGROUND OF THE INVENTION

A portion of the disclosure of this patent document contains materials which are subject to copyright protection. The copyright owner has no objection to the facsimile reproduction by anyone of the patent document or the patent disclosure, as it appears in the Patent and Trademark Office file or records, but otherwise reserves all copyright rights whatsoever.

A. Field of the Invention

The present invention is directed to a plush toy that has use as a bookmark.

B. Discussion of the Prior Art

Bookmarks are well known, and plush toys having the shape, style and overall configuration of animal characters are also well known. It is also known, as illustrated in U.S. Pat. No. 4,934,304, to place a uniquely configured and aesthetically pleasing figure, such as that of an animal, at one end of a clip, thus forming an abutment stop and which may be used as a bookmark.

### OBJECTS AND SUMMARY OF THE INVENTION

It is an object of the present invention to provide a bookmark having a uniquely configured and aesthetically pleasing figure at both ends of a ribbon section of a bookmark to provide an abutment stop at the top and the bottom.

It is a further object of the present invention to provide a bookmark having an upper terminus, a lower terminus and an elastomeric ribbon in between, for use as a bookmark on books of different heights.

If is a further object of the present invention to provide a small, plush toy which is adapted to function as a bookmark in a uncoiled position.

### BRIEF DESCRIPTION OF THE DRAWINGS

FIG. 1 is front, side, perspective view of a first preferred embodiment of the present invention, shown in an expanded condition.

FIG. 2 is a rear, side, perspective view of the FIG. 1 embodiment in an expanded position.

FIG. 3 is front, side, perspective view of the FIG. 1 embodiment shown placed in a book and having its ribbon portion stretched.

FIG. 4 is a rear, side, perspective view of the FIG. 1 embodiment showing the ribbon in a partially wound condition.

FIG. 5 is a rear, side, perspective, partial cross-sectional view of the FIG. 1 embodiment shown with the ribbon in a fully coiled position.

FIG. 6 is a front, side, perspective view of the FIG. 1 embodiment shown with the ribbon in a fully coiled position.

FIG. 7 is a front, side, perspective view of a second embodiment of the present invention.

FIG. 8 is a rear, side, perspective view of the second, alternate embodiment.

FIG. 9 is a front, side, perspective view of a third embodiment of the present invention.

FIG. 10 is a rear, side, perspective view of a third embodiment of the present invention.

FIG. 11 is a rear, side, perspective view of a fourth preferred embodiment of the present invention.

FIG. 12 is a front, side, perspective view of a fourth preferred embodiment of the present invention.

FIG. 13 is a front, side, perspective view of a fifth preferred embodiment of the present invention.

FIG. 14 is a rear, side, perspective view of the fifth preferred embodiment of the present invention.

FIG. 15 is a top, side, perspective view of a sixth preferred embodiment of the present invention.

FIG. 16 is a bottom, side, perspective view of a sixth preferred embodiment of the present invention.

FIG. 17 is a top, side, perspective view of an seventh preferred embodiment of the present invention.

FIG. 18 is a bottom, side, perspective view of the seventh preferred embodiment of the present invention.

FIG. 19 is a bottom, side, perspective view of a eighth preferred embodiment of the present invention.

FIG. 20 is a top, side, perspective view of the eighth preferred embodiment of the present invention.

FIG. 21 is a top, side, perspective view of a ninth preferred embodiment of the present invention.

FIG. 22 is a bottom, side, perspective view of the ninth preferred embodiment of the present invention.

FIG. 23 is a bottom, side, perspective view of a tenth alternate preferred embodiment of the present invention.

FIG. 24 is a top, side, perspective view of the tenth alternate preferred embodiment of the present invention.

### DESCRIPTION OF THE PREFERRED EMBODIMENT(S)

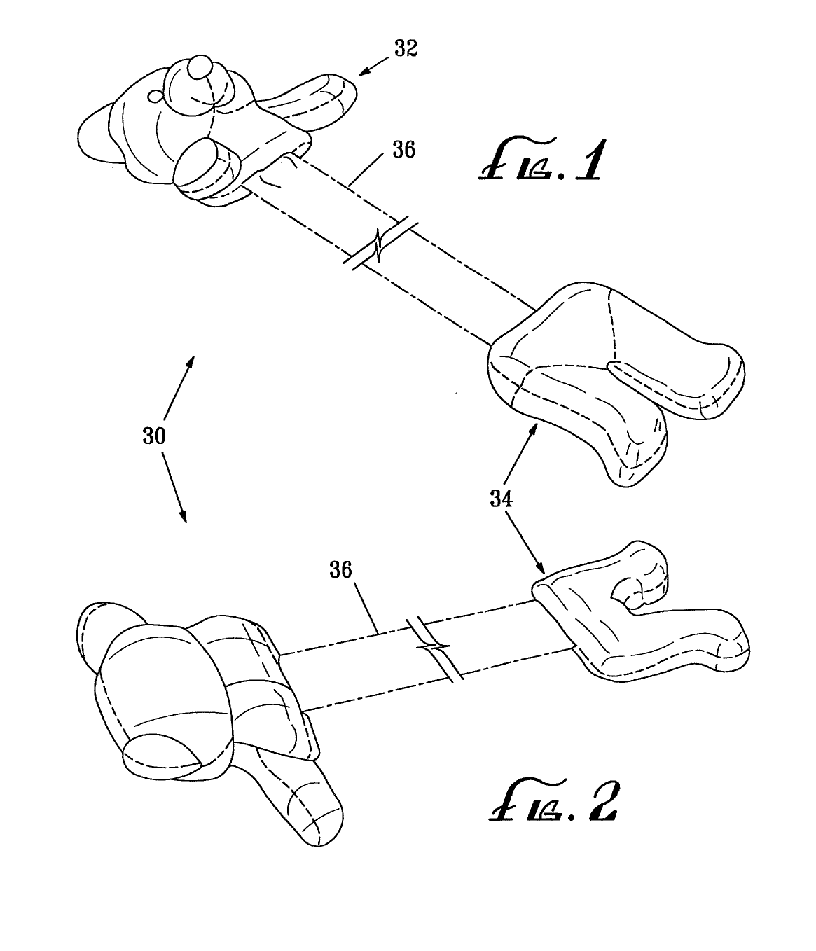

Referring to FIGS. 1-6, a first preferred embodiment of the present plush toy bookmark invention will be described. As shown in FIG. 1 bookmark 30 includes a top, head and torso portion 32; a bottom, torso and leg portion 34, and an intermediate member, preferably in the form of a strip, or ribbon 36, which is firmly attached to the top portion 32 as well as to the bottom portion 34 by any conventional means such as sewing or the equivalent. The present plush toy bookmark invention is intended for use by children as a bookmark. Its upper torso and head portion as well as the lower torso and leg portion are preferably chosen to represent animals or cartoon characters which may be attractive to children. For example, in the FIG. 1 embodiment, the face and forepaws of a bear are shown. Correspondingly, the FIG. 2 rear, perspective view shows the back of the head, ears and torso of the bear character.

As may be seen, the plush toy bookmark of the present invention, provides not only a planar, elongated member that is placed between the pages of a book as a place marking, but also provides a unique way to secure the marker without having to physically attach to the page, such as, for example, a clip, and to secure the marker at both ends of the book. Moreover, the plush toy ends of the bookmark provide a pleasing appearance to children, and may be used as toys separate and apart from their function as bookmarks.

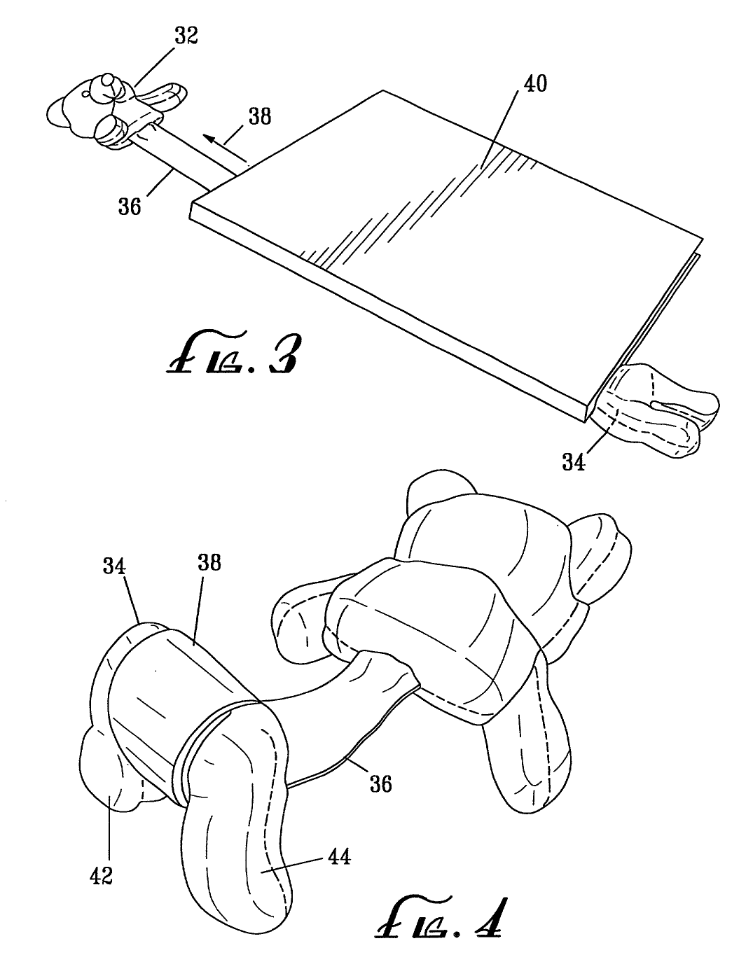

The strip, or ribbon 36 is preferably of a thin, cloth or cloth like material which can be placed between pages of a book and along its spine to function as a bookmark. The ribbon is preferably of a durable and will enable a firm connection to the top torso portion 32 and the bottom torso portion 34 to be made. Also, as a preferable option, the ribbon 36 may be of an elastomeric material so that it may stretch to accommodate the different heights of different books, as shown for example, in FIG. 3. Preferably the length of the ribbon 36 is chosen to accommodate the most popular or some known sizes of children's books. However, in an embodiment wherein the ribbon 36 is made of elastomeric material, it will permit the bookmark 30 to be used with different sized books 40.

The upper torso portion 32, as well as the lower torso portion 34 are, preferably, 3-dimensional plush toys. As such, they function as abutments or anchors for the ribbon 36 of the bookmark. Other 3-dimensional forms, whether inanimate objects or representations of characters, may be used as abutment, or stop members as well. Because of their dimensions and firm attachment to the ribbon 36, the upper portion 32 and lower portion 34 function to keep the bookmark in place and not fall through the book when the book is picked up by the child. They also serve as a ready identifier for the location of the bookmark. With the present invention being incorporated into different characters, such as an elephant, cat, rabbit and so forth, it is believed that a particular child may choose a particular character as a favorite for use as a bookmark and/or as a toy.

Referring to FIGS. 4, 5, and 6, the ribbon 36 is shown wrapped or coiled around the lower torso to provide for shortening the effective length of the ribbon and/or to convert the bookmark to be a small, plush toy. As shown in FIG. 4, the ribbon 36 has been rolled around the lower torso portion 34 several times to form a roll 38. Preferably, the legs 42 and 44 of the lower torso portion are constructed so that they either point inward or have a bowed shape so that the distal ends of the legs and/or the knee regions of the legs have a distance between them in a resting position that is less than the width of the ribbon 36. Thus, when winding the ribbon 36 around the lower torso portion 34, the legs 42 and 44 must be spread apart so that the winding 38 can be accomplished. When the ribbon 36 is fully wound around the lower torso portion 34, the legs 42 and 44 are released, and they return to their original position, and as such perform a holding function to keep the winding 38 in place, i.e., prevent it from uncoiling.

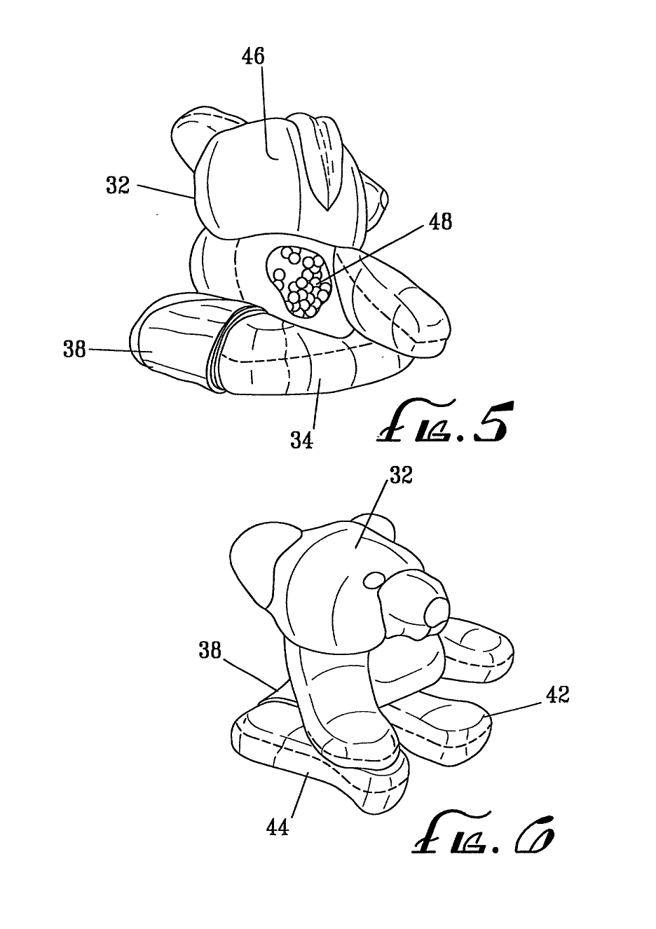

As shown in FIGS. 5 and 6, a rear, side, perspective, and a front, side, perspective view, the ribbon 36 has been fully wound around the lower torso portion 34 and the legs 42 and 44 are in their relaxed position. In this way, the ribbon 36 has been wound into a tight coil 38 which is kept in place by the pincher action of the legs 42 and 44. In this fashion, the bookmark of the present invention can be stored or used as a little, plush toy.

The upper torso and lower torso portions of the bookmark of the present invention are plush toys as that term is well known and used. Referring to FIG. 5, for example, the plush toy has an exterior covering 46 made of a plush material such as, for example, a polyester. The filler material, shown at 48 in FIG. 5 are typically PVC pellets, or beans, peas or other naturally occurring materials having a mean diameter of several millimeters.

As shown above, the first preferred embodiment of the present invention, as shown in FIGS. 1-6, has the shape, style and overall configuration of a bear.

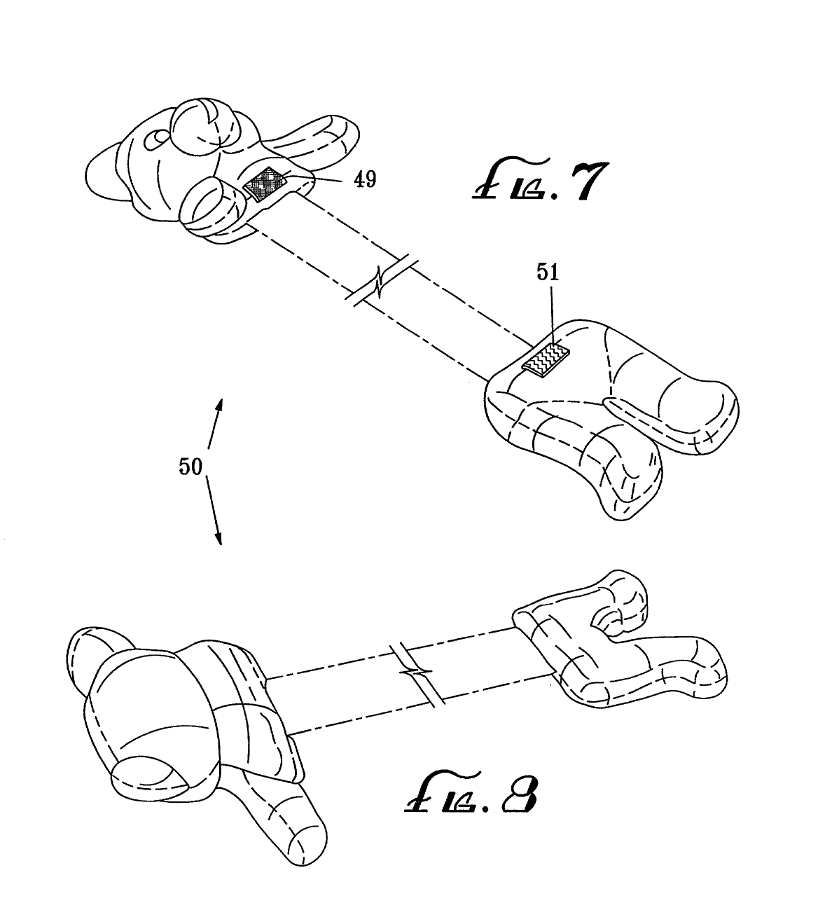

Referring to the alternate embodiment 50 illustrated in FIGS. 7 and 8, the torso and head portions have the shape, style and overall configuration of a panda. This alternate embodiment also illustrates the use of fasteners on the plush toy so that it may be used as a bracelet or otherwise attached circumferentially around an object. Specifically, Velcro brand fastening patches 49, and 51 are attached to the upper torso portion and lower torso portion of the toy, on the under side, so that, for example, the toy could be wrapped around a child's wrist, arm, leg, etc., and the Velcro brand fasteners stuck together to form a type of bracelet. Alternately, the fastening patches could be placed on the outside portions of the toy, however, preferably they are placed as shown in FIG. 7.

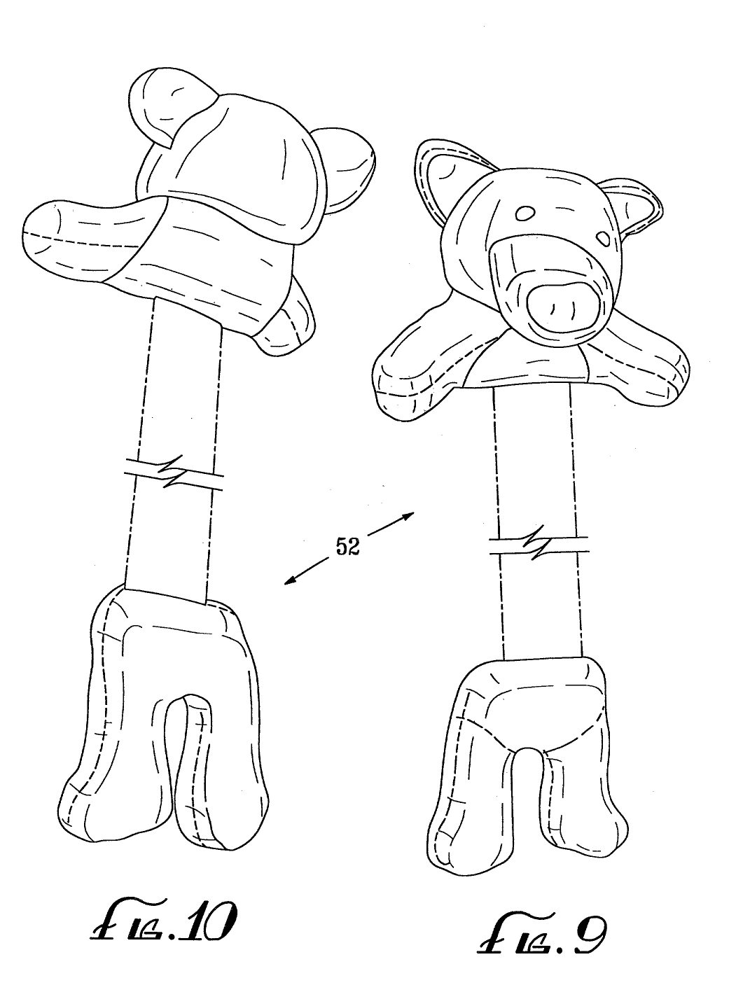

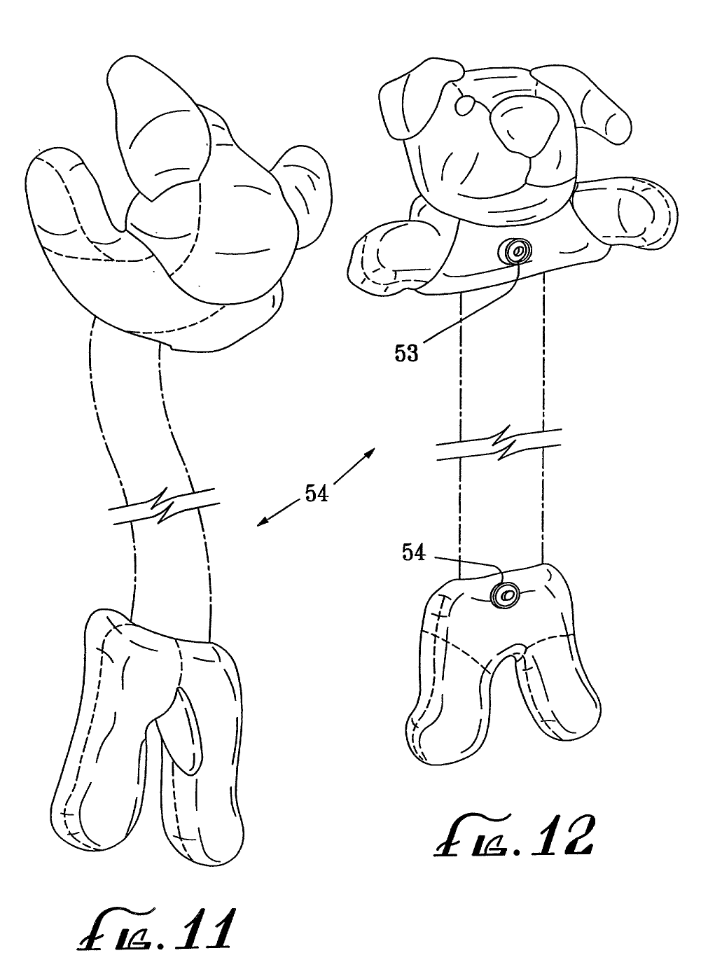

The alternate embodiment 52 of FIGS. 9 and 10, has a shape, style and overall configuration of a pig. 5 The embodiment 54 shown in FIGS. 11 and 12 is characterized as a dog. The FIG. 12 embodiment shows an alternate fastener, which functions as does the fastener shown and described above with respect to FIG. 7. In the FIG. 12, fastener, a conventional snap fastener is shown, with a female portion 53 attached, conventionally, to the upper torso and the male portion 54 of the snap fastener attached, conventionally, to the lower torso.

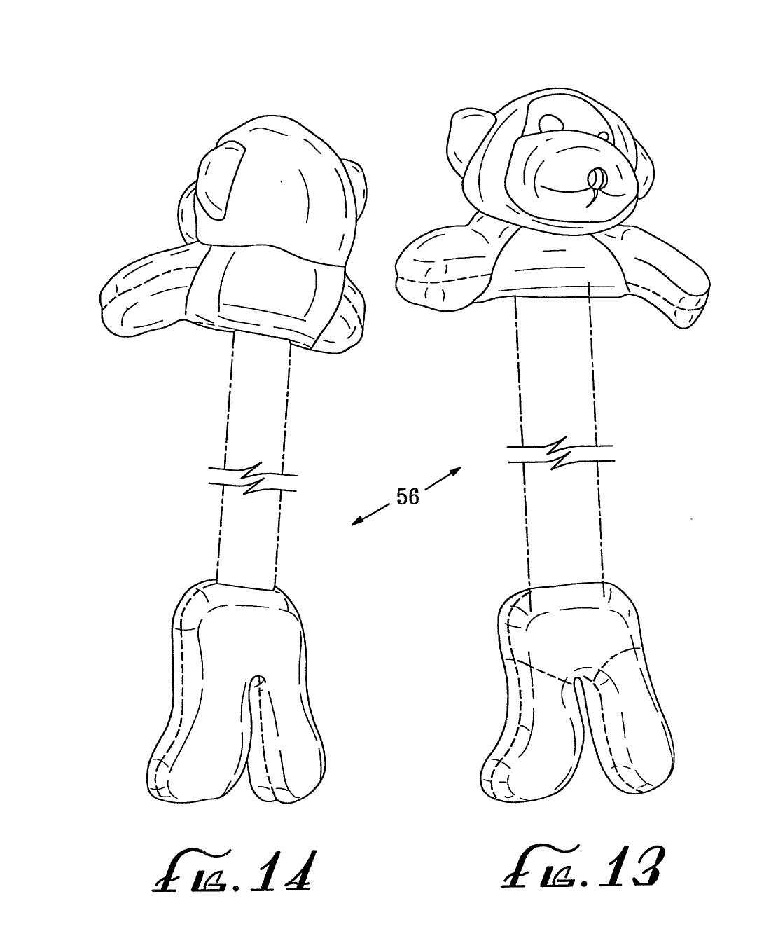

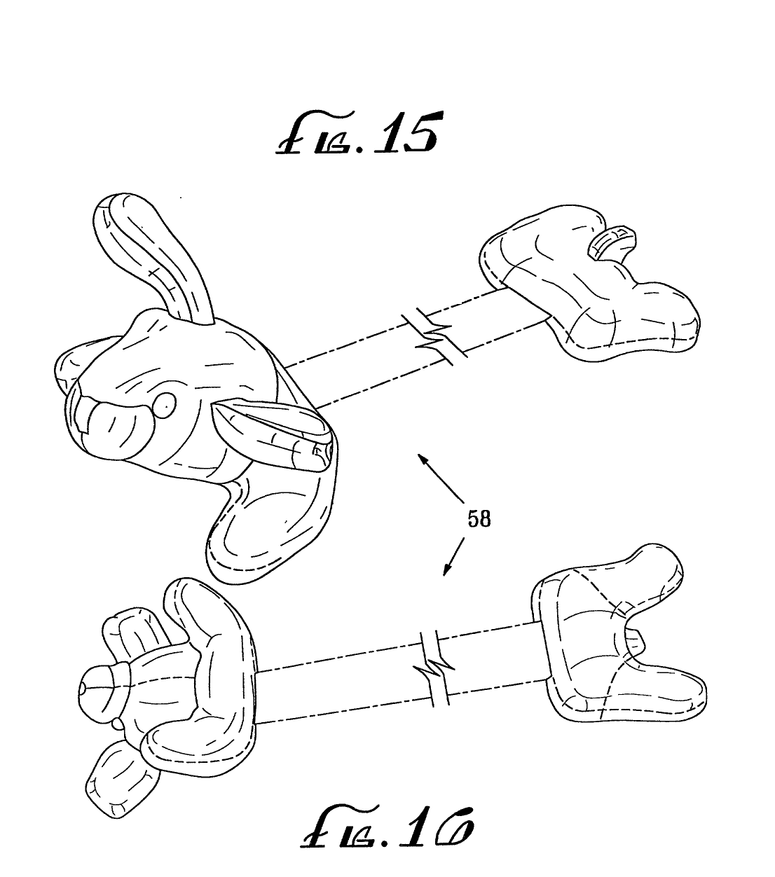

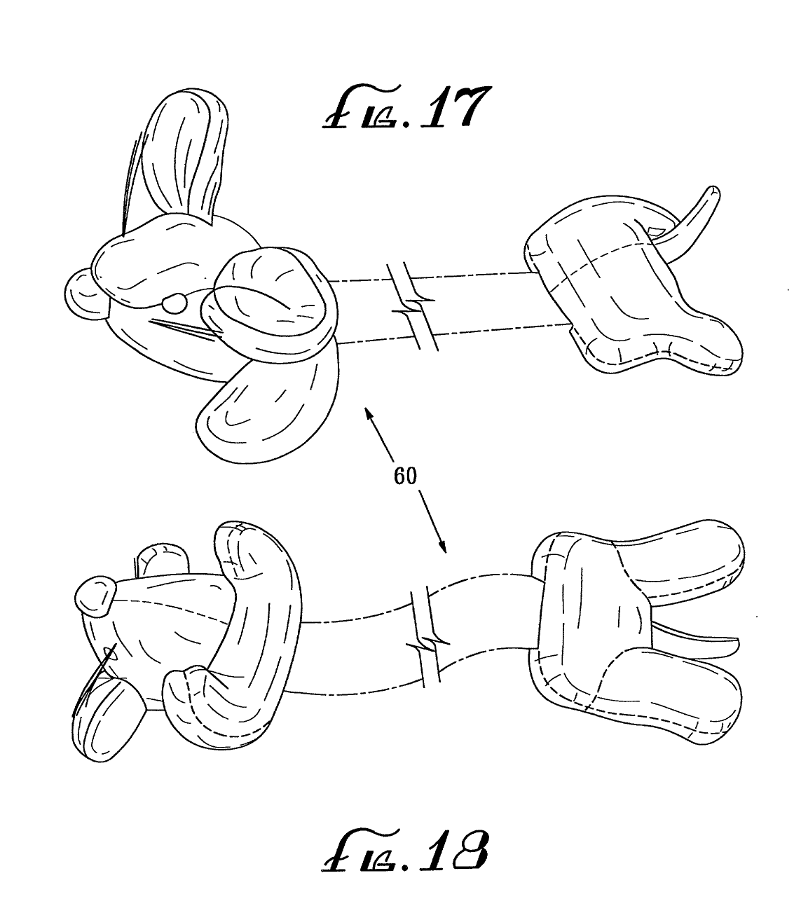

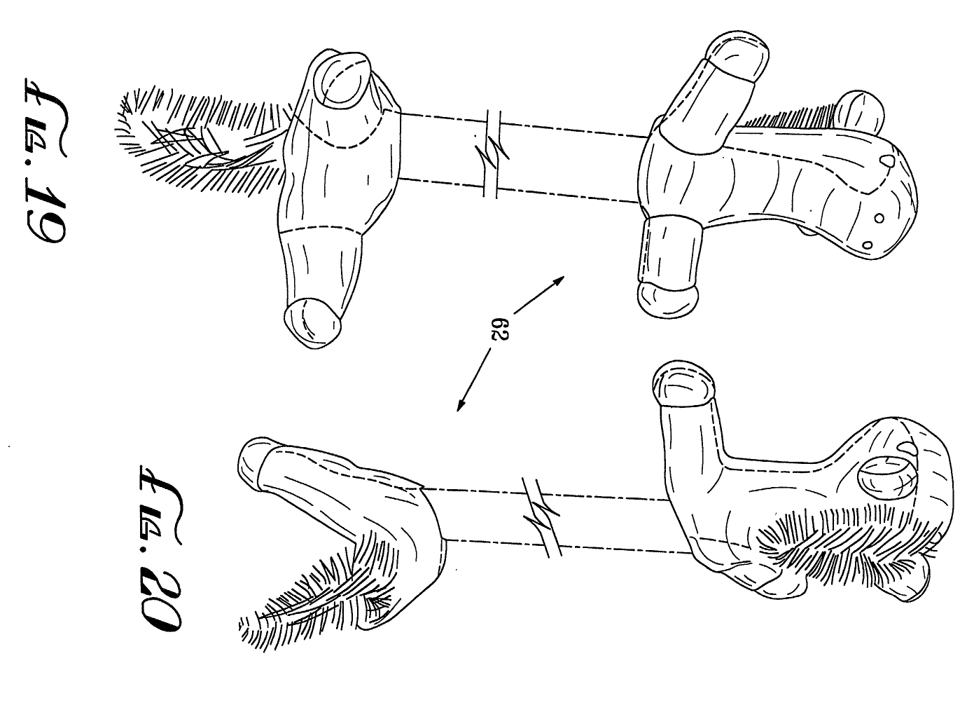

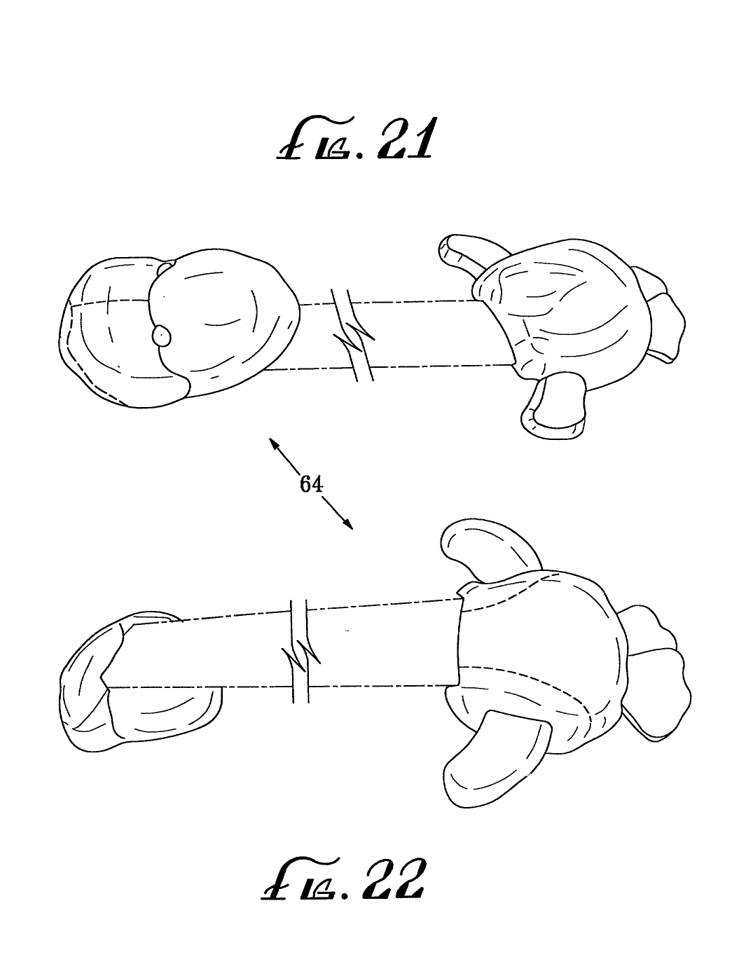

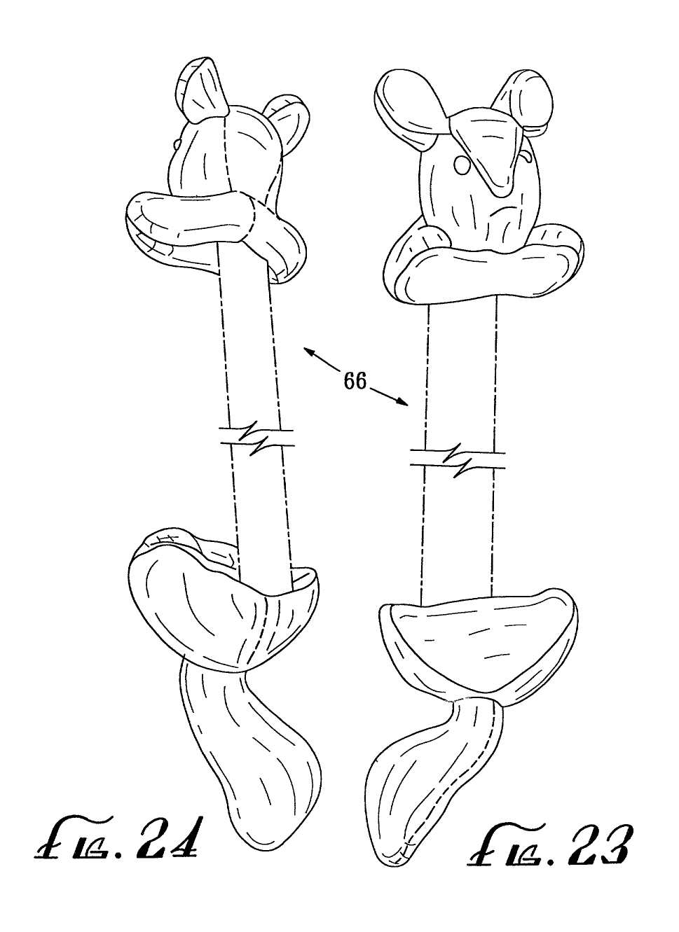

Referring to the alternate embodiment 56 FIGS. 13 and 14, a monkey is illustrated. The embodiment 58 FIGS. 15 and 16 has a shape, style and overall configuration of a rabbit and a mouse is shown in the embodiment 60 illustrated in FIGS. 17 and 18. In FIGS. 19 and 20, a zebra 62 illustrated and in FIGS. 21 and 22 a duck 64 shown. Finally, the embodiment 66 shown in FIGS. 23 and 24 is a representation of a squirrel.

While the invention has been described in terms of what are presently considered to be the most practical and preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A bookmark comprising:
an intermediate member having a predetermined length, width and being sufficiently thin to extend between pages of a book and along the length of the spine of the book without stretching its binding;
a first abutment member having a length dimension, a width dimension and a thickness dimension, and attached to a first end of the intermediate member; and
a second abutment member having a length dimension, a width dimension and a thickness dimension, and attached to a second end of the intermediate member.

2. The bookmark of claim 1 wherein the first abutment member is a representation of a portion of an animal.

3. The bookmark of claim 1 wherein the first abutment member is a representation of a human.

4. The bookmark of claim 1 wherein the intermediate member is a ribbon.

5. The bookmark of claim 1 wherein the intermediate member is made of an elastomeric material.

6. The bookmark of claim 1 wherein the second abutment member includes a representation of two limbs, with the distal portions of the limbs having, in their resting position, a distance therebetween that is less than the width of the ribbon.

7. The bookmark of claim 1 wherein the second abutment member is adapted to have the intermediate member wound there around.

8. A plush toy bookmark comprising:
a ribbon having a predetermined length, width and being sufficiently thin to extend between pages of a book and along the length of the spine of the book without stretching its binding;
a plush toy representation of the upper torso, forelimbs and head of a character attached to a first end of the ribbon; and
a plush toy representation of the lower torso and hind limbs of the character attached to the second end of the ribbon.

9. The bookmark of claim 8 wherein the character is an animal.

10. The bookmark of claim 8 wherein the character is humanoid.

11. The bookmark of claim 8 wherein the ribbon is made of an elastomeric material.

12. The bookmark of claim 8 wherein the lower torso limbs include distal portions having, in their resting position, a distance therebetween that is less than the width of the ribbon.

13. The bookmark of claim 9 wherein the lower torso is adapted to have the ribbon wound there around and into a coil whereby a small plush toy oriented in a sitting position is provided.

14. A plush toy bookmark comprising:
a ribbon adapted to extend between two pages of a book and along the length of the spine of the book;
a three-dimensional, plush toy representation of the upper torso, forelimbs and head of an animal character attached to a first end of the ribbon;
a three-dimensional plush toy representation of the lower torso and rear limbs of the animal character attached to the second end of the ribbon, the rear limbs having a shortest distance between them in a resting position being less than the width of the ribbon and adapted to be spread apart;
whereby the ribbon may be coiled around the lower torso when the rear limbs are spread apart and is held in a coiled position by the rear limbs in their resting position to provide a small plush toy animal in a sitting position.

15. The bookmark of claim 14 wherein the ribbon is made of an elastomeric material.
